(19) United States
(12) Patent Application Publication
(10) Pub. No.: US 2023/0226399 A1
(43) Pub. Date: Jul. 20, 2023

(54) RETENTION COLLAR FOR A CYLINDRICAL ELEMENT

(71) Applicant: Bells of Steel Inc., Calgary (CA)

(72) Inventors: Adam Yousfi, Warsaw (PL); Kaevon Khoozani, Russell (CA)

(21) Appl. No.: 18/096,962

(22) Filed: Jan. 13, 2023

Related U.S. Application Data
(60) Provisional application No. 63/266,808, filed on Jan. 14, 2022.

(51) Int. Cl. A63B 21/072; F16B 2/06

(52) U.S. Cl. CPC A63B 21/0728; F16B 2/06; A63B 21/0724

(57) ABSTRACT

The present document relates to retention collars for use with weight plates and a cylindrical element, such as a barbell, designed to receive the weight plates. The retention collar comprises a body with an expansion opening, and an opening mechanism. The opening mechanism comprises a first radial tab extending from the body adjacent to a first side wall of the expansion opening and a second radial tab extending from the body adjacent to a second side wall of the expansion opening with a tab-receiving aperture for receiving the first radial tab therethrough. When the first and second radial tabs are squeezed together, the diameter of the center aperture increases to receive the cylindrical element therethrough. When the opening mechanism is released, the center aperture returns to its original diameter and retains the weight plates on the barbell.

### CROSS-REFERENCE TO RELATED

This application claims priority from U.S. Provisional Patent Application 63/266,808 filed on Jan. 14, 2022 and is incorporated by reference herein.

### TECHNICAL FIELD

The present disclosure relates to fitness equipment. In particular, the present disclosure relates to retention collars for a cylindrical body, such as a barbell.

### BACKGROUND

Recreational or competitive weightlifting, such as bodybuilding, weight training, powerlifting, etc., often use weight plates in conjunction with a cylindrical bar, such as a barbell. The weight plates can be removably placed on each end of the cylindrical bar to allow the user to adjust the weight throughout their training regiment without requiring the bar to be replaced.

Conventional weight plates are disc shaped with a cylindrical hole in the middle to receive the cylindrical bar. Once placed on the end of the cylindrical bar, the weight plates are secured to the cylindrical bar using a sleeve collar or clamp. A conventional spring collar includes a coiled body with a hole for receiving the cylindrical bar, and two radial arms. In a resting state, the two radial arms are angled outwardly from each other. When the radial arms are pulled together by the user, the coiled body expands and the diameter of the hole increases, allowing the spring collar to be slide onto the cylindrical bar. Once the user releases the radial arms, the coiled body contracts to its resting state and retains the weight plates on the cylindrical bar. However, these collars are often comprised of metal, which can cause damage to the cylindrical bar and increase the overall production cost of the collars. Furthermore, the tightly coiled body can make opening the spring collar difficult (i.e., the radial arms can be difficult to squeeze together).

There are also clamp-style collars that use a cam lever or other lever-based closing mechanism to tighten the cylindrical body around the bar. However, these collars have multiple moving parts allowing the cam lever to close the closing mechanism, thus clamping the collar onto the cylindrical bar. Thus, these collars have higher manufacturing and maintenance costs.

In view of the above, there is a need for more cost effective and efficient devices that would be able to overcome or at least minimize some of the above-discussed prior art concerns.

### SUMMARY

It is therefore an aim of the present invention to address the above mentioned issues.

According to a general aspect, there is provided a retention collar for securing an object on a cylindrical element, the retention collar comprising: a body defining a center aperture for receiving the cylindrical element, the body having an expansion opening extending through the body from an inner surface of the center aperture to an outer surface of the body to define a first side wall and a second side wall; and an opening mechanism operatively coupled to the body and positioned adjacent to the expansion opening, the opening mechanism comprising: a first radial tab extending from the body adjacent to the first side wall of the expansion opening; and a second radial tab extending from the body adjacent to the second side wall of the expansion opening, wherein the second radial tab comprises a tab-receiving aperture and the first radial tab extends through the tab-receiving aperture towards the second side wall of the expansion opening; wherein the body is biased in the closed configuration and movable to an open configuration when pressure is applied to the first radial tab and the second radial tab; and wherein a diameter of the center aperture is greater in the open configuration than in the closed configuration.

In some embodiments, the outer surface of the body further comprises ridges extending radially out from the body.

In some embodiments, the ridges are spaced apart to create grooves between each of the ridges.

In some embodiments, at least one of the ridges has a hole extending therethrough.

In some embodiments, at least one of the ridges has an additional groove extending through the at least one of the ridges along a circular path of the body.

In some embodiments, at least one of the ridges comprises a surface configured to display a logo or advertisement.

In some embodiments, the outer surface further comprises a surface configured to display a logo or advertisement.

In some embodiments, the retention collar is manufactured with 3D printing.

In some embodiments, the first radial tab and the second radial tab are integral to the body.

In some embodiments, the first radial tab and the second radial tab are operatively connected to the body with fasteners.

In some embodiments, the interior surface of the body that defines the center aperture is a ring sized and configured to retain the retention collar on the cylindrical element when the retention collar is in the closed configuration.

In some embodiments, the interior surface of the body that defines the center aperture is comprised of ridges sized and configured to retain the retention collar on the cylindrical element when the retention collar is in the closed configuration.

In some embodiments, at least a portion of the interior surface of the body is comprised of a gripping material.

In some embodiments, the gripping material is a compressible material.

In some embodiments, the body is comprised of a 3D printing filament.

In some embodiments, the first radial tab and the second radial tab are comprised of a 3D printing filament.

In some embodiments, the 3D printing filament is comprised of at least one of a thermoplastic, an organic polymer, a synthetic polymer, acrylonitrile styrene acrylate (ASA), acrylonitrile butadiene styrene (ABS), polylactic acid (PLA), polyethylene terephthalate (PETG), nylon, poly(vinylalcohol) (PVA), PLA metal, PLA carbon fiber, lignin, thermoplastic polyurethane (TPU), thermoplastic elastomers (TPE), thermochromism plastics, or phosphorescence plastics.

In some embodiments, the diameter of the center aperture in the closed configuration is equal to or smaller than a diameter of the cylindrical element.

In some embodiments, the diameter of the center aperture is less than 50 mm when in the closed configuration.

In some embodiments, the diameter of the center aperture is between about 46 mm and about 49 mm when in the closed configuration.

In some embodiments, the retention collar is configured to secure weight plates on a barbell, a curl bar, a dumbbell, a hex bar, or a trap bar.

In some embodiments, the first side wall and the second side wall are abutting when in the closed configuration and are spaced-apart from each other when in the open configuration.

According to another aspect, there is provided a barbell in combination with a retention collar for securing an object on the barbell, the retention collar comprising: a cylindrical body defining a barbell-receiving aperture, the cylindrical body circumscribing the barbell when received in the barbell-receiving aperture, the cylindrical body having an expansion opening extending therethrough to define a first side wall and a second side wall, the first side wall abutting against the second side wall in a closed configuration of the cylindrical body and being spaced-apart from one another in an open configuration wherein a diameter of the barbell-receiving aperture is greater than in the closed configuration; and an opening mechanism mounted to the cylindrical body and positioned adjacent to the expansion opening, the opening mechanism comprising: a first radial tab extending from a first side of the expansion opening; and a second radial tab extending from a second side of the expansion opening, wherein the second radial tab comprises a tab-receiving aperture and the first radial tab extends through the tab-receiving aperture towards the second side of the expansion opening and wherein the cylindrical body is biased in the closed configuration and the cylindrical body is configurable in the open configuration by applying pressure onto the first and the second radial tabs.

In some embodiments, the outer surface of the body further comprises ridges extending radially out from the body.

In some embodiments, the ridges are spaced apart to create grooves between each of the ridges.

In some embodiments, at least one of the ridges has a hole extending therethrough.

In some embodiments, at least one of the ridges has an additional groove extending through the at least one of the ridges along a circular path of the body.

In some embodiments, at least one of the ridges comprises a surface configured to display a logo or an advertisement.

In some embodiments, the body comprises an outer surface configured to display a logo or advertisement.

In some embodiments, the retention collar is manufactured with 3D printing.

In some embodiments, the first radial tab and the second radial tab are integral to the body.

In some embodiments, the first radial tab and the second radial tab are operatively connected to the body with fasteners.

In some embodiments, an interior surface of the body that defines the center aperture is a ring sized and configured to retain the retention collar on the barbell when the retention collar is in the closed configuration.

In some embodiments, an interior surface of the body that defines the center aperture is comprised of ridges sized and configured to retain the retention collar on the barbell when the retention collar is in the closed configuration.

In some embodiments, at least a portion of an interior surface of the body that defines the center aperture is comprised of a gripping material.

In some embodiments, the gripping material is a compressible material.

In some embodiments, the body of the retention collar is comprised of a 3D printing filament.

In some embodiments, the first radial tab and the second radial tab are comprised of a 3D printing filament.

In some embodiments, the 3D printing filament is comprised of at least one of a thermoplastic, an organic polymer, a synthetic polymer, acrylonitrile styrene acrylate (ASA), acrylonitrile butadiene styrene (ABS), polylactic acid (PLA), polyethylene terephthalate (PETG), nylon, poly(vinylalcohol) (PVA), PLA metal, PLA carbon fiber, lignin, thermoplastic polyurethane (TPU), thermoplastic elastomers (TPE), thermochromism plastics, or phosphorescence plastics.

In some embodiments, the diameter of the center aperture in the closed configuration is equal to or smaller than a diameter of a sleeve of the barbell.

In some embodiments, the diameter of the center aperture is less than 50 mm when in the closed configuration.

In some embodiments, the diameter of the center aperture is between about 46 mm and about 49 mm when in the closed configuration.

### BRIEF DESCRIPTION OF THE DRAWINGS

In order that the invention may be readily understood, embodiments of the invention are illustrated by way of example in the accompanying drawings.

FIG. 1 is a plan front view of a retention collar according to a first embodiment of the present invention;

FIG. 2 is a plan side view of the retention collar shown in FIG. 1;

FIG. 3 is a plan bottom view of the retention collar shown in FIG. 1;

FIG. 4 is a perspective front view of 3-dimensional rendering of the retention collar shown in FIG. 1;

FIG. 5 is a front plan view of a retention collar according to another embodiment of the present invention that has been 3D printed;

FIG. 6 is a perspective side view of the retention collar shown in FIG. 5; and

FIG. 7 is a perspective side view of the retention collar shown in FIG. 5 in use with a cylindrical element and weight plates.

### DETAILED DESCRIPTION

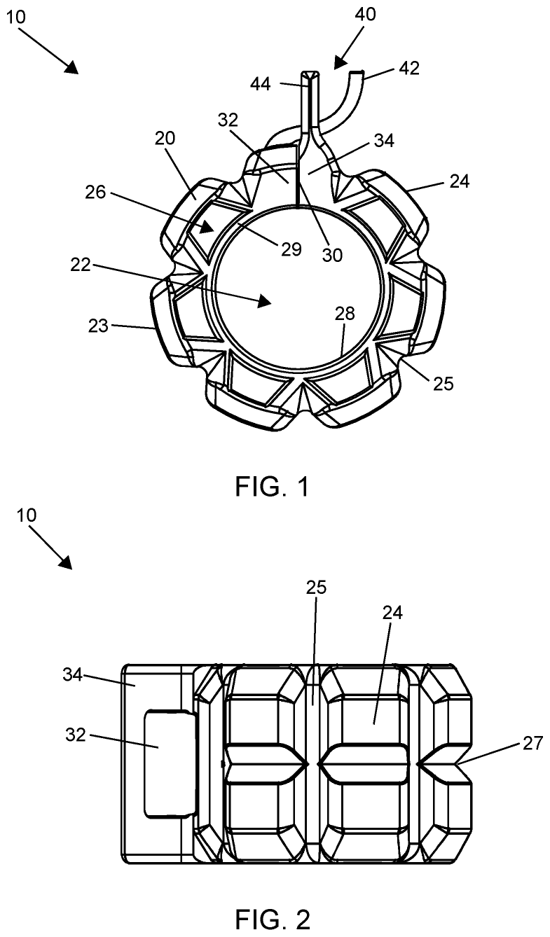

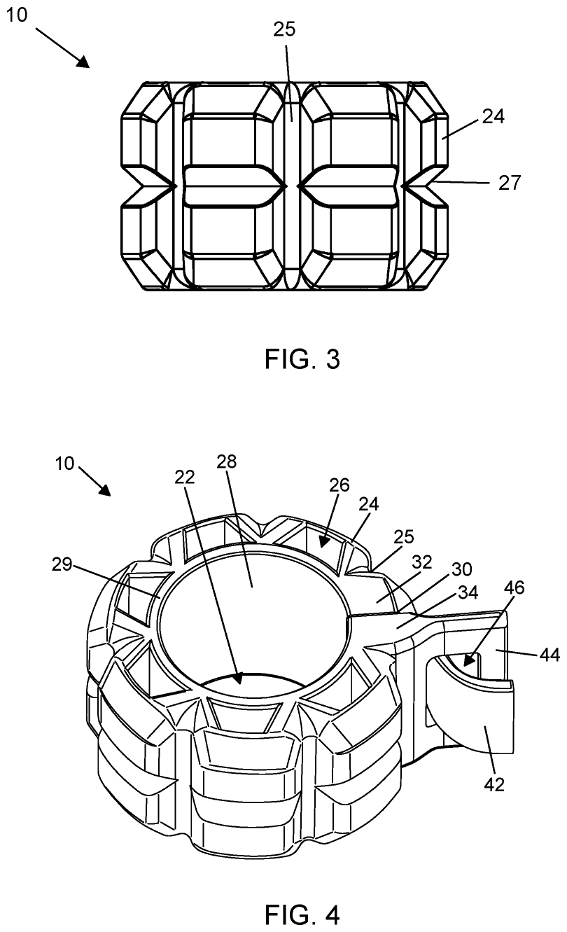

Referring now to FIGS. 1 to 4, a retention collar 10 for securing an object on a cylindrical element is shown. The retention collar comprises a body 20 with an expansion opening 30 that is operatively coupled to an opening mechanism 40. The body 20 defines a center aperture 22 that is configured to receive the cylindrical element, such as the sleeve on a barbell, curl bar, dumbbell, hex bar, or trap bar. The body 20 has an expansion opening 30 extending therethrough, which provides some flexibility in the body 20 to increase the diameter of the center aperture 22 when the opening mechanism 40 is actuated. The center aperture 22 is configured to have a diameter that is slightly smaller than the outer diameter of the cylindrical element when the retention collar 10 is in the closed or rested configuration. For example, when the retention collar 10 is used with a barbell, the diameter of the center aperture 22 can be around 46 to 49 mm, which is slightly smaller than the outer diameter of a standard barbell sleeve, which is 50 mm. When the opening mechanism 40 is actuated (i.e., squeezed together), the expansion opening 30 in the body 20 spreads apart to slightly to increase the diameter of the center aperture 22 and allow the retention collar 10 to be slide onto the cylindrical element. When the opening mechanism 40 is released, the center aperture 22 returns to its original diameter and retains the weight plates on the cylindrical element.

The opening mechanism 40 is operatively attached to the body 20 on either side of the expansion opening 30. The expansion opening 30 extends through the body 20 to create a first side wall 32 and a second side wall 34. When the body is cylindrical in shape, the expansion opening 30 can extend through the curved or lateral surface from the top circular plane surface to the bottom circular plane surface. However, it is understood that an outer surface 23 of the body 20 can be any shape and that the expansion opening 30 should extend from an inner surface 28 of the center aperture 22 to the outer surface 23 of the body 20 along the entire depth of the body 20 to allow the circumference of the center aperture 22 to expand when the opening mechanism 40 is actuated. For example, referring now to FIG. 1, the expansion opening 30 extends from the outer surface 23 to the inner surface 28 and from the front side of the body 20 (shown) to the back side of the body 20 (not shown).

The opening mechanism 40 comprises a first radial tab 42 and a second radial tab 44. The second radial tab 44 further comprises a tab-receiving aperture 46 configured to receive the first radial tab 42 therethrough. The first radial tab 42 extends radially out from the body 20 adjacent to the first side wall 32 of the expansion opening 30 and through the tab-receiving aperture 46 towards the second side wall 34 of the expansion opening 30. The second radial tab 44 extends radially out from the body 20 adjacent to the second side wall 34 of the expansion opening 30. In some embodiments, the second radial tab 44 can extend across the expansion opening 30 towards the first side wall 32. It is understood that, while the first radial tab 42 and the second radial tab 44 traverse each other over the expansion opening 30, the expansion opening 30 should not be impeded from separating when the opening mechanism 40 is actuated, such as to create a gap between the first side wall 32 and the second side wall 34.

To increase the diameter of the center aperture 22, the user can actuate the opening mechanism 40 by squeezing the first radial tab 42 and the second radial tab 44 together (i.e., applying pressure onto the first radial tab 42 and the second radial tab 44) to move the retention collar 10 into the open configuration. When squeezed together, the traversed first radial tab 42, which is connected to the body 20 adjacent to the first side wall 32 of the expansion opening 30, pushes the first side wall 32 away from the second side wall 34 to create a gap between the first side wall 32 and the second side wall 34, thus slightly increasing the diameter of the center aperture 22 to facilitate sliding the retention collar 10 onto the cylindrical element.

The body 20 comprises an outer surface 23, which can have any shape provided that the center aperture 22 is a shape and size that will grip to the cylindrical element the retention collar 10 is being used with to a sufficient degree that will retain the weight plates placed on the cylindrical element. For example, in some embodiments, the body 20 can have a substantially cylindrical profile or can be defined by other shapes that define a center aperture 22, such as a hollow prism with a constant cross-section, such as a hexagonal prism or octagonal prism, or a hollow polyhedron, such as a dodecahedron. In some embodiments, the body 20 circumscribes the cylindrical element when the cylindrical element is received in the center aperture 22. However, in other embodiments, the body 20 could have a shape that only partially surrounds the cylindrical element when the cylindrical element is received in the center aperture 22. For example, when in the closed configuration, the first side wall 32 and the second side wall 34 of the expansion opening 30 could be spaced-apart, as long as the portion of the body 20 surrounding the cylindrical element is sufficient to create an interference fit that retains the object on the cylindrical element.

In the embodiment shown in FIGS. 1 to 4, the outer surface 23 of the body 20 comprises ridges 24 extending radially from the body 20 and grooves 25 between the ridges 24. The ridges 24 can further comprise holes 26 that extend therethrough and/or additional grooves 27 that extend across the ridge 24 along the circular path of the body 20. In some embodiments, the grooves 25, holes 26, and/or the additional grooves 27 can reduce the overall weight and/or material used in the construction of the retention collar 10 without reducing the structural integrity of the body 20.

The shape of the center aperture 22 is defined by an interior surface 28 of the body 20. The interior surface 28 of the embodiments shown is a smooth, circular ring 29 that corresponds to the surface of the cylindrical element the retention collar 10 is used with. However, the interior surface 28 can have any shape or configuration that will grip to the cylindrical element it is used in conjunction with. For example, the interior surface 28 can have ridges and grooves, where the ridges are configured to grip to the cylindrical element. Other embodiments may have an interior surface 28 with bumps, indentations, or other textures configured to grip to the cylindrical element. In some embodiments, the ring 29 can be eliminated, such that the bottom or interior surface of the grooves 25 form the interior surface 28 of the center aperture 22. In some embodiments, the interior surface 28 can be covered, at least in part, by a gripping element. For example, portions of the ring 29 can be covered with a gripping element or, when the body 20 does not include the ring 29, the bottom or interior surface of the grooves 25 can be covered with a gripping element. The gripping element can be any suitable material that will facilitate a tight interference fit with the cylindrical element. In some embodiments, the gripping element can be a flexible or compressible material, such as rubber or foam. Compressible materials have the advantage of reducing their volume when the retention collar 10 is in the closed configuration, such that the gripping material is compressed against the cylindrical element, and providing a tighter interference fit.

The retention collar 10 can be comprised of any suitable material that provides enough flexibility for the body 20 to expand the size of the center aperture 22 when the first radial tab 42 and the second radial tab 44 are actuated. In some embodiments, the body 20 can be comprised of a resilient material. The shape and configuration of the body 20 is such that the body 20 is biased in the closed configuration (i.e., when the opening mechanism 40 is not actuated and the expansion opening 30 is closed such that the first side wall 32 and the second side wall 34 are abutting, touching or are separated only slightly by a gap). When in the closed configuration, the center aperture 22 has a diameter that generally corresponds to the outer diameter of the cylindrical element the retention collar 10 is configured for use with. In some embodiments, the diameter of the center aperture 22 is slightly smaller than the outer diameter of the cylindrical element to facilitate an interference fit with the cylindrical element when the retention collar 10 is on the cylindrical element in the closed configuration.

When choosing a suitable material for the body 20, consideration should be given to the amount of force required to actuate the opening mechanism 40 (i.e., squeezing the first radial tab 42 and the second radial tab 44 together). In some implementations, the retention collar 10 can be comprised of a 3D printing filament to enable quick and inexpensive 3D printing manufacturing. For example, the retention collar 10 can be comprised of thermoplastics, organic polymers, or synthetic polymers, such as acrylonitrile styrene acrylate (ASA), acrylonitrile butadiene styrene (ABS), polylactic acid (PLA), polyethylene terephthalate (PETG), nylon, poly(vinylalcohol) (PVA), PLA metal, PLA carbon fiber, lignin, thermoplastic polyurethane (TPU), thermoplastic elastomers (TPE), thermochromism plastics, phosphorescence plastics, etc. As the first radial tab 42 and the second radial tab 44 traverse each other, with the first radial tab 42 extending through the tab-receiving aperture 46 on the second radial tab 44, injection molding manufacturing may be precluded if the retention collar 10 is manufactured as an integral, undivided piece.

In some embodiments, the body 20 can be manufactured using a mold, such as injection molding manufacturing and the first radial tab 42 and the second radial tab 44 can be manufactured separately and fastened adjacent to the first side wall 32 and the second side wall 34 of the expansion opening 30, respectively. In this embodiment, the body 20 can be comprised of a flexible or resilient material that allows the first side wall 32 and the second side wall 34 of the expansion opening 30 to be spaced apart from each other when the retention collar 10 is placed in the open configuration (i.e., when the first radial tab 42 and the second radial tab 44 are squeezed together). In some embodiments, the body 20 and the opening mechanism 40 are comprised of the same material; however, the first radial tab 42 and the second radial tab 44 can be comprised of a different material that is rigid or flexible. For example, the first radial tab 42 and the second radial tab 44 can be comprised of a rigid material, such as metal, and can optionally be covered with a material that facilitates ease of use, such as rubber or a grip.

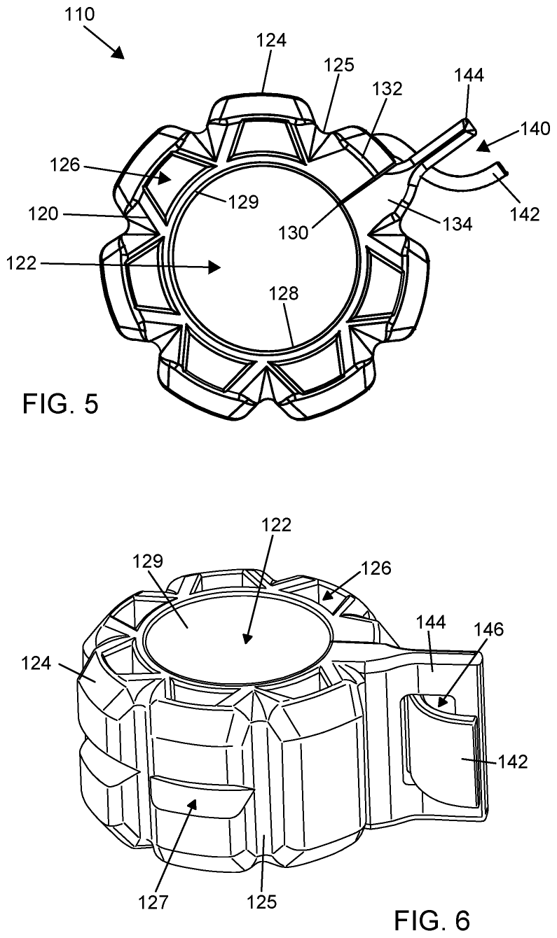

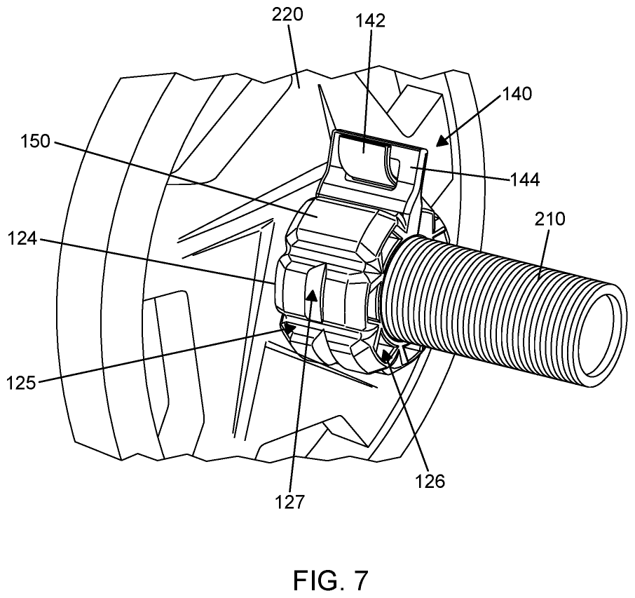

Referring now to FIGS. 5 to 7, a retention collar 110 according to another embodiment is shown. The retention collar comprises a body 120 having an expansion opening 130, and an opening mechanism 140 operatively coupled to the body adjacent to the expansion opening 130. The body 120 defines a center aperture 122 that is configured to receive a cylindrical element. The body 120 can further comprise an outer surface 123 with ridges 124 extending radially from the body 120 and grooves 125 between the ridges 124. The ridges 124 can further comprise holes 126 that extend therethrough and/or additional grooves 127 that extend across the ridge 124 along the circular path of the body 120. The center aperture 122 has an inner surface 128 that comprises a ring 129. The inner surface 128 and/or the ring 129 are configured to grip to the cylindrical element when the retention collar 110 is in the closed configuration (i.e., when the opening mechanism 140 is not actuated) to retain the weight plates on the cylindrical element.

The body 120 can further comprise a surface 150 to display a logo or advertisement. For example, as shown in FIG. 7, the body 120 includes a ridge 124 that does not have an additional groove 127, such that the ridge 124 creates a surface 150 where a logo can be imprinted, embossed, engraved, or molded, or, alternatively, where a printed medium, such as a sticker, can be affixed.

The opening mechanism 140 is comprised of a first radial tab 142 extending from the body 120 adjacent to a first side wall 132 of the expansion opening 130 and a second radial tab 144 extending from the body 120 adjacent to a second side wall 134 of the expansion opening 130. The second radial tab 144 further comprises a tab-receiving aperture 146 configured to receive the first radial tab 142 therethrough. The first radial tab 142 extends radially out from the body 120 adjacent to the first side wall 132 of the expansion opening 130 and through the tab-receiving aperture 146 towards the second side wall 134 of the expansion opening 130. Accordingly, when the first radial tab 142 is pushed against the second radial tab 144, the first radial tab 144 pushes the first side wall 132 of the expansion opening 130 away from the second side wall 134 of the expansion opening 130, thus increasing the space between the first side wall 132 and the second side wall 134 of the expansion opening 130.

Referring now to FIG. 7, the retention collar 110 is shown on a sleeve 210 of a barbell. As can be seen, the retention collar 110 is in the closed configuration with the sleeve 210 extending through the center aperture 122. The retention collar 110 is placed directly against or close to the weight plates 220 being retained on the barbell. To remove the retention collar 110, either to add more weight plates 220 or remove the weight plates 220, the user actuates the opening mechanism 140 by squeezing the first radial tab 142 and the second radial tab 144 together to move the retention collar 110 into the open configuration. Actuation of the opening mechanism 140 increases the diameter of the center aperture 122, such that the retention collar 110 can be easily removed from the sleeve 210 by sliding off the distal end of the sleeve 210. When the user actuates the opening mechanism 140, the first radial tab 142 is pushed towards the second radial tab 144. The pressure exerted on the first radial tab 142 pushes the first side wall 132 of the expansion opening 130 away from the second side wall 132 of the expansion opening 130 such that the spaced-apart relationship between the first side wall 132 and the second side wall 132 of the expansion opening 130 increases, thus increasing the diameter of the center aperture 122. When the first radial tab 142 and the second radial tab 144 are pressed together, the expansion opening 130 is temporarily opened or expanded against the bias of the body 120 to the closed configuration, thus allowing the retention collar 110 to be slide on or off of the cylindrical element, such as the sleeve 210. When the first radial tab 142 and the second radial tab 144 are released, the body 120 is biased in the closed configuration and the expansion opening 130 closes or contracts to the biased position with the first side wall 132 and the second side wall 134 abutting each other, thus reducing the diameter of the center aperture 122 to its diameter in the closed configuration. As the diameter of the center aperture 122 in the closed configuration matches or is slightly smaller than the outer diameter of the cylindrical element, in this case the sleeve 210, the retention collar 110 is retained tightly on the sleeve 210 via an interference fit.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A retention collar for securing an object on a cylindrical element, the retention collar comprising
a body defining a center aperture for receiving the cylindrical element, the body having an expansion opening extending through the body from an inner surface of the center aperture to an outer surface of the body to define a first side wall and a second side wall; and
an opening mechanism operatively coupled to the body and positioned adjacent to the expansion opening, the opening mechanism comprising
a first radial tab extending from the body adjacent to the first side wall of the expansion opening; and
a second radial tab extending from the body adjacent to the second side wall of the expansion opening,
wherein the second radial tab comprises a tab-receiving aperture and the first radial tab extends through the tab-receiving aperture towards the second side wall of the expansion opening;
wherein the body is biased in the closed configuration and movable to an open configuration when pressure is applied to the first radial tab and the second radial tab; and
wherein a diameter of the center aperture is greater in the open configuration than in the closed configuration.

2. The retention collar of claim 1, wherein the outer surface of the body further comprises ridges extending radially out from the body.

3. The retention collar of claim 2, wherein the ridges are spaced apart to create grooves between each of the ridges.

4. The retention collar of claim 2, wherein at least one of the ridges comprises:
a hole extending therethrough;
an additional groove extending through the at least one of the ridges along a circular path of the body; and/or
a surface configured to display a logo or advertisement.

5. The retention collar of claim 1, wherein the outer surface further comprises a surface configured to display a logo or advertisement.

6. The retention collar of claim 1, wherein the retention collar is manufactured with 3D printing.

7. The retention collar of claim 1, wherein the first radial tab and the second radial tab are integral to the body.

8. The retention collar of claim 1, wherein the first radial tab and the second radial tab are operatively connected to the body with fasteners.

9. The retention collar of claim 1, wherein the interior surface of the body that defines the center aperture is comprised of a ring or ridges, wherein the ring or the ridges are sized and configured to retain the retention collar on the cylindrical element when the retention collar is in the closed configuration.

10. The retention collar of claim 1, wherein at least a portion of the interior surface of the body is comprised of a gripping material.

11. The retention collar of claim 10, wherein the gripping material is a compressible material.

12. The retention collar of claim 1, wherein the body is comprised of a 3D printing filament.

13. The retention collar of claim 1, wherein the first radial tab and the second radial tab are comprised of a 3D printing filament.

14. The retention collar of claim 12, wherein the 3D printing filament is comprised of at least one of a thermoplastic, an organic polymer, a synthetic polymer, acrylonitrile styrene acrylate (ASA), acrylonitrile butadiene styrene (ABS), polylactic acid (PLA), polyethylene terephthalate (PETG), nylon, poly(vinylalcohol) (PVA), PLA metal, PLA carbon fiber, lignin, thermoplastic polyurethane (TPU), thermoplastic elastomers (TPE), thermochromism plastics, or phosphorescence plastics.

15. The retention collar of claim 1, wherein the diameter of the center aperture in the closed configuration is equal to or smaller than a diameter of the cylindrical element.

16. The retention collar of claim 1, wherein the diameter of the center aperture is less than 50 mm when in the closed configuration.

17. The retention collar of claim 16, wherein the diameter of the center aperture is between about 46 mm and about 49 mm when in the closed configuration.

18. The retention collar of claim 1, wherein the retention collar is configured to secure weight plates on a barbell, a curl bar, a dumbbell, a hex bar, or a trap bar.

19. The retention collar of claim 1, wherein the first side wall and the second side wall are abutting when in the closed configuration and are spaced-apart from each other when in the open configuration.

20. A barbell in combination with a retention collar for securing an object on the barbell, the retention collar comprising
a cylindrical body defining a barbell-receiving aperture, the cylindrical body circumscribing the barbell when received in the barbell-receiving aperture, the cylindrical body having an expansion opening extending therethrough to define a first side wall and a second side wall, the first side wall abutting against the second side wall in a closed configuration of the cylindrical body and being spaced-apart from one another in an open configuration wherein a diameter of the barbell-receiving aperture is greater than in the closed configuration; and
an opening mechanism mounted to the cylindrical body and positioned adjacent to the expansion opening, the opening mechanism comprising
a first radial tab extending from a first side of the expansion opening; and
a second radial tab extending from a second side of the expansion opening,
wherein the second radial tab comprises a tab-receiving aperture and the first radial tab extends through the tab-receiving aperture towards the second side of the expansion opening; and
wherein the cylindrical body is biased in the closed configuration and the cylindrical body is configurable in the open configuration by applying pressure onto the first and the second radial tabs.
